(19) United States
(12) Patent Application Publication
(10) Pub. No.: US 2005/0117571 A1
(43) Pub. Date: Jun. 2, 2005

(54) Distribution of time division multiplexed data through packet connections

(76) Inventor: Robert Gordon Dyke, North Easton, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/820,436

(22) Filed: Apr. 6, 2004

Related U.S. Application Data
(60) Provisional application No. 60/525,929, filed on Dec. 1, 2003.

(51) Int. Cl. H04L 12/66; H04L 12/28; H04L 12/50

(52) U.S. Cl. 370/355; 370/376

(57) ABSTRACT

One aspect relates to a system and method for distributing TDM data using a packet-based infrastructure. In particular, a system and method is provided for distributing time division multiplexed (TDM) data through low latency connections between TDM conversion entities. In one example, a packet-to-TDM conversion method and device is provided that allows transport of TDM data over a packet-based infrastructure, and a method is provided to create and delete connections among separate conversion devices connected via the transport mechanism. The transport mechanism may include a packet transport such as Ethernet. Data may be switched based on MAC header information in an Ethernet frame. Because, according to one example, the network has a low latency in transmission of TDM data, receivers may be implemented without buffering, and therefore receiver circuitry may be less-expensive.

### RELATED APPLICATIONS

This application claims priority under 35 U.S.C. § 119(e) to U.S. Provisional Application Ser. No. 60/525,929, entitled “DISTRIBUTION OF TIME DIVISION MULTIPLEXED DATA THROUGH PACKET CONNECTIONS,” filed on Dec. 1, 2003, which is herein incorporated by reference in its entirety.

### FIELD OF THE INVENTION

The field of the invention relates generally to digital communication, and more particularly, to communicating time division multiplexed (TDM) data.

### BACKGROUND OF THE INVENTION

Traditionally, telecom and other voice oriented processing systems have used a serialized shared media time division multiplexed (TDM) bus to distribute 64 Kbps 8 bit data (referred to in the art as a time slot) between modules (e.g., circuit boards, chips, circuit elements, etc.) within a chassis. Examples of these busses include, for example, the Enterprise Computer Telephony Forum (ECTF) H.110 bus and the MVIP bus.

FIG. 1 shows an example of a conventional inter-circuit board TDM distribution system using multi-drop serial time division multiplexed connections. As shown, circuit boards 2A-2B in the chassis use a time slot interchanger 3 to arrange data to be sent to or received from the shared media bus 1. A synchronizer (e.g., synchronizer 5A, synchronizer 5B) provides a bit clock to time transmission of TDM data sent (in a serial manner) over the shared media, and a framing pulse that typically occurs every 125 microseconds. Synchronizers 5A-5B generally include timing buses 4A-4B, respectively, that are distributed among circuit boards in a system. Synchronizers 5A-5B ensure the TDM busses on the circuit boards are synchronous to an external timing source. Synchronizers 5A-5B can be implemented as part of an interface circuit board or as a centralized function, and may be redundant (e.g., synchronizer 5A and 5B may provide redundant functions to each circuit board). Also, there may be more than one external timing source from which a synchronizer may select.

Systems have been created based on switched serial links to transmit TDM data. These systems distribute data in packet form using either a mesh of point-to-point connections between circuit boards or a centralized switch with full duplex serial connections to each circuit board. An example of this type of new system is the Advanced Telecom Computing Architecture (AdvancedTCA) architecture defined by the PCI Industrial Computer Manufacturers Group in the PICMG 3.0 Core Specification.

### SUMMARY

One aspect of the present invention relates to a system and method for distributing TDM data using a packet-based infrastructure. In particular, a system and method is provided for distributing time division multiplexed (TDM) data through low latency connections between TDM conversion entities. In one embodiment of the invention, a packet-to-TDM conversion method and device is provided that allows transport of TDM data over a packet-based infrastructure, and a method is provided to create and delete connections among separate conversion devices connected via the transport mechanism. The transport mechanism may include a shared-media packet transport such as Ethernet.

According to another aspect of the invention, a system-wide bus is created by packing timeslots from a source TDM bus into packets, and transmitting the packets to a destination circuit board where they are removed from the packet and placed onto another TDM bus.

In one example system, the connections may be point-to-point network connections, or packet-switched connections made through one or more switching entities. These connections may be, for example, low-latency connections such as Ethernet connections. By using an inexpensive packet transport mechanism such as Ethernet, the cost associated with creating a TDM-based switch is reduced, as the cost of Ethernet components is inexpensive as compared to custom TDM bus hardware. These connections may also be full-duplex connections, either direct connections or switched through a packet switch. In one embodiment, Ethernet frames are used to transport TDM data. These frames may be sent directly between TDM conversion entities, or through a packet switch. In one embodiment, the packet switch is a data link switch that forwards data without inspecting network layer information, thus further decreasing latency.

According to another aspect of the present invention, a bi-directional TDM/packet conversion device is provided that captures serialized TDM data and converts the data into a packet payload to be sent in the transmit direction. In the receive direction, the conversion device unpacks a packet payload, converts the payload data to serialized TDM data, and places the serialized data on a TDM bus.

In one embodiment, a packet connection is created between the source module and the destination module, the connection being either switched or a direct connection, having a latency less than a TDM frame period. By keeping latency low, (e.g., on the order of 10's of microseconds vs. 10-100s of milliseconds) the amount of buffering necessary is minimized and circuitry is simplified. This latency compares to conventional TDM busses that generally have a frame period of 125 microseconds between circuit boards and chassis. In another embodiment, the packet connection delivers packets to the destination in the order they were received from the source. The packet connection should preferably minimize packet loss.

According to another aspect of the invention, a message based protocol is provided that allows communication between a connection entity, a TDM packet source, and a TDM packet destination to create and delete connections. The system may include a simple out-of-band synchronization mechanism to ensure TDM frame synchronization between source and destination modules. Further, the synchronization mechanism may ensure bit clocks used for serialized TDM busses are synchronous. According to another embodiment, at least one of the packets carrying TDM data includes a packet payload configuration change indicator. In one example, the indicator indicates that the packet's payload contents have changed by one or more bytes. This indicator may, for example, be carried in a header of the packet or may be transmitted as a separate out of band signal.

According to another embodiment, a system is provided that provides an ability to operate in a 1+1 redundant manner where a device receives the same packetized TDM data on both a primary and a secondary connection simultaneously. This capability allows the device to emulate a circuit switched digital cross connect. Further, according to another embodiment, a system may include an ability to extend connections across multiple chassis using standard serial links to connect the chassis to a packet switch or network of switches. These links may be, for example, Ethernet links that transmit TDM data in Ethernet frames.

According to one aspect of the invention in a data communication system, a method for distributing time division multiplexed (TDM) data is provided. The method comprises acts of receiving, from at least one TDM source, at least one time timeslot associated with a TDM communication, inserting the at least one received timeslot into a packet, and transmitting the packet to a destination capable of recovering the at least one timeslot from the transmitted packet. According to one embodiment of the invention, the method further comprises an act of receiving the packet, and forwarding the timeslot to at least one TDM destination, wherein the TDM source and TDM destination are located on at least one circuit board within a communication system. According to another embodiment of the invention, the at least one TDM source is a TDM bus, and wherein the act of receiving further comprises receiving the at least one timeslot from the TDM bus. According to another embodiment of the invention, the act of transmitting the packet further comprises an act of transmitting the packet to the destination over a packet-based network. According to one embodiment of the invention, the packet-based network includes an Ethernet network. According to another embodiment of the invention, the packet-based network transmits timeslot data over a full-duplex connection. According to one embodiment of the invention, the shared media network includes at least one packet switch, and wherein the act of transmitting further comprises an act of forwarding the packet by the at least one packet switch toward the destination.

According to another embodiment of the invention, the act of forwarding includes an act of determining where to forward the packet based on Ethernet MAC header information only. According to one embodiment of the invention, the packet-based network includes a point-to-point connection between an entity associated with the TDM source and an entity associated with the TDM destination, and wherein the act of transmitting further comprises an act of transmitting the packet over the point-to-point connection. According to one embodiment of the invention, the TDM bus has an associated TDM frame period, and wherein a latency associated with transmitting the packet is less than a TDM frame period. According to one embodiment of the invention, the method further comprises an act of receiving the packet at the destination, wherein the act of receiving does not include the use of a jitter buffer at the destination.

According to another embodiment of the invention, the act of inserting the at least one received timeslot into a packet, includes an act of inserting the at least one timeslot into a payload section of the packet. According to one embodiment of the invention, the packet includes data link information, and wherein the act of transmitting the packet further comprises an act of transmitting the packet based only on the data link information. According to one embodiment of the invention, the act of transmitting further comprises an act of transmitting, in parallel, the packet to the destination over a plurality of redundant connections. According to another embodiment of the invention, the act of transmitting the packet includes transmitting the packet substantially simultaneously over the plurality of redundant connections.

According to another embodiment of the invention, the act of transmitting further comprises an act of transmitting the packet in order compared to one or more other packets having one or more timeslots from the at least one TDM source. According to another embodiment of the invention, the act of transmitting the packet further comprises an act of transmitting the packet to the destination over a packet-based network, and wherein the act of transmitting the packet further comprises transferring the packet and the one or more other packets to the destination in order. According to one embodiment of the invention, the act of transmitting the packet further comprises an act of transmitting the packet to the destination over a packet-based network to another data communication system associated with the destination. According to another embodiment of the invention, the method further comprises an act of indicating, to the destination when data in the at least one timeslot has changed. According to one embodiment of the invention, the method further comprises an act of providing a synchronization signal to the at least one TDM source and to the destination. According to another embodiment of the invention, the act of providing the synchronization signal includes an act of providing the synchronization signal via a network separate from a network over which the packet is transmitted.

According to another aspect of the invention, a system for communicating TDM data comprises a first TDM communication entity that is adapted to receive at least one timeslot, the timeslot associated with a TDM connection, and a second TDM communication entity coupled to the first TDM communication entity through a packet-based network, wherein the first TDM communication entity is adapted to transmit a packet to the second TDM communication entity through the packet-based network, the packet including the at least one timeslot. According to one embodiment of the invention, the system further comprises at least one packet switch that couples the first TDM communication entity to the second TDM communication entity, and wherein the at least one packet switch is adapted to forward the packet to the second TDM communication entity. According to another embodiment of the invention, the system further comprises a synchronizer coupled to the first TDM communication entity and the second TDM communication entity, the synchronizer providing a synchronization signal to the first TDM communication entity and the second TDM communication entity.

According to another embodiment of the invention, the synchronizer is coupled to the first TDM communication entity and the second TDM communication entity separately from the packet-based network. According to one embodiment of the invention, the synchronizer provides the synchronization signal to the first TDM communication entity and the second TDM communication entity over at least one connection, the at least one connection being separate from the packet-based network. According to one embodiment of the invention, the latency associated with transmitting the packet to the second TDM communication entity is less than one TDM frame period, and wherein the second TDM communication entity does not implement a jitter buffer to receive one or more packets.

Further features and advantages of the present invention as well as the structure and operation of various embodiments of the present invention are described in detail below with reference to the accompanying drawings. In the drawings, like reference numerals indicate like or functionally similar elements. Additionally, the left-most one or two digits of a reference numeral identifies the drawing in which the reference numeral first appears. All references cited herein are expressly incorporated by reference.

### BRIEF DESCRIPTION OF THE DRAWINGS

The foregoing and other objects, features and advantages of the invention will be apparent from the following more particular description of the preferred embodiments of the invention, as illustrated in the accompanying drawings in which like reference characters refer to similar elements. In the drawings,

FIG. 1 illustrates a prior art distribution of TDM data to circuit boards within a chassis using multi-drop shared media serial time division multiplexed connections;

FIG. 2 shows a distribution of TDM data between two circuit boards within a chassis using point-to-point packet connections according to one embodiment of the present invention;

FIG. 3 shows an example distribution of TDM data among circuit boards within a chassis using a packet switch to forward packets to individual circuit boards over point-to-point serial packet connections in accordance with one embodiment of the present invention;

FIG. 4 shows an example distribution of TDM data among circuit boards within a chassis using a full mesh of point-to-point serial packet connections in accordance with one embodiment of the present invention;

FIG. 5 shows an example distribution of TDM data between circuit boards within a chassis using a mesh of point-to-point serial packet connections and a packet switch on each circuit board to distribute packets between functions on a circuit board in accordance with one embodiment of the present invention;

FIG. 6 shows an example of pipelined processing steps that may be used in distributing TDM data via a packet connection;

FIG. 7 shows an example process for creating a connection between a source circuit board and a destination circuit board;

FIG. 8 shows an example process for deleting a connection between a source circuit board and a destination circuit board; and

FIG. 9 shows an example distribution of TDM data among four chassis using a packet switch to forward packets to individual chassis over point-to-point serial packet connections.

### DETAILED DESCRIPTION OF THE INVENTION

One aspect of the invention relates to a system and a method for distributing time division multiplexed (TDM) data through inter-circuit board connections in a TDM communication system. A method and apparatus for converting TDM data to packet data performs a function referred to hereinafter as a Virtual Computer Telephony (VCT) function that allows transport of TDM data over a packet-based network. More particularly, the VCT function communicates TDM data between entities using a packet-based network. Conventionally, TDM communication systems use either a custom TDM bus or serial links to connect entities in the communication system, leading to more complex and expensive designs.

Further, the VCT function creates and deletes connections among separate VCT entities (e.g., circuit boards) connected via the transport mechanism. A system-wide VCT bus may therefore be created by packing timeslots from a source TDM bus into packets and transmitting these packets through connections to a destination entity, such as a circuit board that communicates TDM data. At the destination entity, the timeslot data is removed from the packet and placed onto another TDM bus.

In one example system, TDM data may be transmitted over low latency connections. These low latency connections may be, for example, direct or switched Ethernet connections as discussed above. Although it should be appreciated that various aspects of the invention may be operated with other types of transports, it is realized that Ethernet is preferable due to the availability of low cost Ethernet components and low-latency Ethernet switching devices.

According to one aspect of the present invention, it is realized that the use of a jitter buffer at a receiver is not required, reducing the cost of receiver circuitry. Because a jitter buffer is not used, latency is low. According to one aspect of the present invention, it is realized that with low latency connections, a fast failover mechanism can realized with parallel connections between a sender and receiver, as more fully described below. In conventional circuit emulation systems (CES), jitter buffer circuitry is used. A CES-based system that uses a jitter buffer cannot detect and respond as quickly to a failed connection as a system that does not implement such a buffer. Rather, a system according to one embodiment is provided that uses synchronous pipelined frame processing.

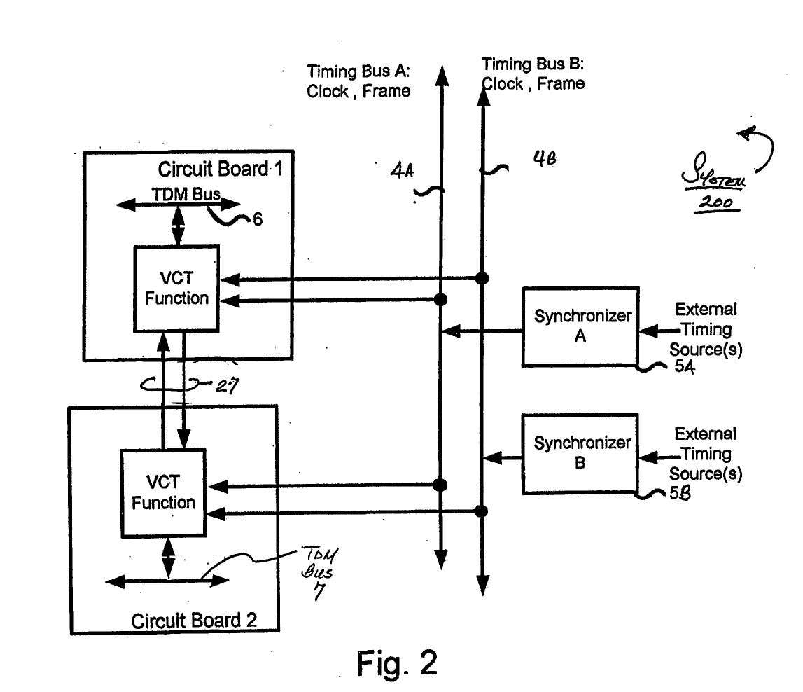

FIG. 2 shows a distribution of TDM data between two elements of a TDM communication system 200 using packet data according to one embodiment of the present invention. Timeslots received from a TDM bus 6 are placed into a payload of one or more transmitted packets that are transmitted over an inter circuit board connection 27 to one or more entities, such as another circuit board. The received timeslots are removed from the packets and placed on a TDM bus (e.g., bus 7) on another circuit board. According to one aspect of the present invention, the packet format may be a packet having a format according to the Ethernet protocol. A full duplex TDM connection could be created by taking timeslots from TDM bus 7, placing the timeslots into packets, transmitting them through the inter-circuit board connection 27, and removing the timeslots from packets and placing the timeslots on TDM Bus 6. Although only two circuit boards are shown having a single VCT function and TDM bus, it should be appreciated that a system may have any number of circuit boards, VCT functions, or TDM busses.

TDM bus frame and bit clocks may be synchronized via external timing sources. For instance, synchronizers 5A-5B provide frame and bit clocks to circuit boards within the chassis to which the VCT functions are synchronized. In one example, synchronizers 5A-5B create timing pulses for all of the circuit boards within a chassis by synchronizing to external clock sources and driving clock lines of the appropriate frequency to all the circuit boards in the system. However, it should be appreciated that the system may have any number and configuration of synchronizers and the invention is not limited to any particular configuration.

Alternatively, a packet switch can be used to connect VCT functions located on the same or separate circuit boards. For instance, an Ethernet switch having characteristics as defined further below may be suitable for performing such a connection.

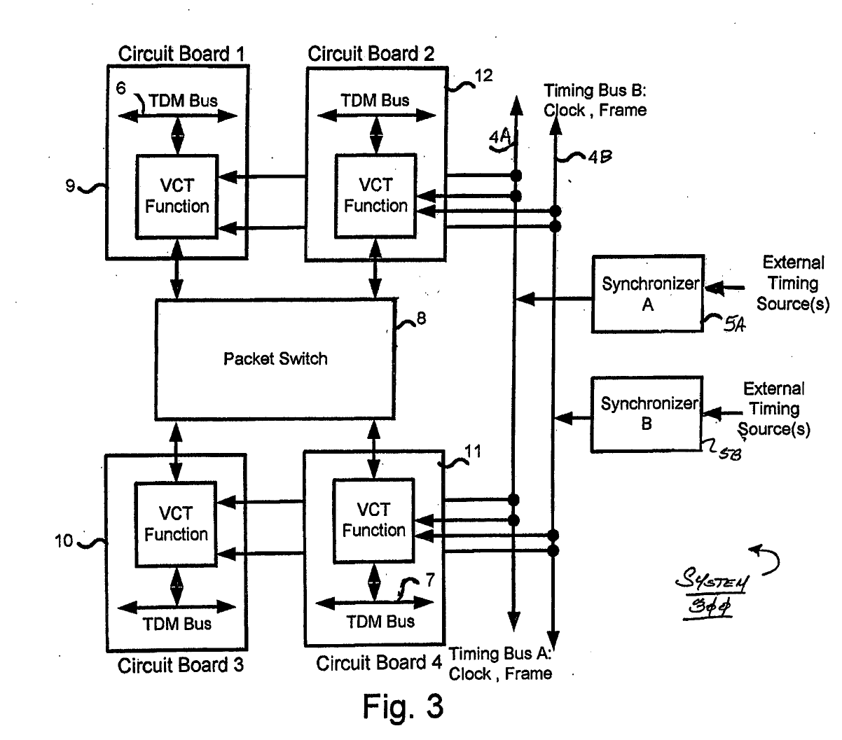

FIG. 3 shows an example of circuit boards (items 9, 10, 11, and 12) coupled by a packet switch. According to one embodiment, the packet switch may be a layer 2 (data link layer) switch that forwards packets based on MAC header information (e.g., source and destination MAC addresses).

As shown in FIG. 3, timeslots from a circuit board 9 having a TDM bus 6 can be placed into packets, sent through a packet switch 8, removed from packets and placed on a TDM bus of another circuit board (e.g., TDM bus 7 of circuit board 11). A full duplex TDM connection may be created by taking timeslots from TDM bus 7, placing them into packets, sending them through the packet switch to circuit board 9, and removing them from packets and placing them on TDM bus 6. Systems using two or more circuit boards can be built in this fashion.

TDM bus frame and bit clocks are synchronous within the system. Each circuit board in the system may have one or more TDM busses, each of which may receive or provide TDM data. As discussed above, redundant synchronizers 5A-5B may then provide frame and bit clocks for one or more circuit boards. Synchronizers may, for example, create timing pulses for all of the circuit boards within a chassis by synchronizing themselves to external clock sources. Synchronizers 5A-5B may then drive clock lines of the appropriate frequency to circuit boards in the system. According to one embodiment, a synchronizer ensures the TDM busses on the circuit boards are synchronous to an external timing source. Synchronizers 5A-5B can be implemented, for example, as part of an interface circuit board or as a centralized function, and may be redundant. Also, there may be more than one external source that a synchronizer may select from.

The amount of VCT traffic supported by the system is design-dependent, and depends in large part, on the number of time slots needed to be transmitted, and the number of destinations supported. An upper bound on the bandwidth needed on the link to the VCT function can be derived, for example, using Equation 1 below. According to one embodiment, connections are full duplex, point-to-point connections. More particularly, each VCT function is interconnected in the switching system via full duplex serial links. The system design preferably does not overload any serial link to ensure that packets are not lost or delayed excessively in transport. In addition, in one example system, VCT traffic may share a serial link with non-VCT packets and therefore this loading may be factored into the desired loading of the system and switch links.

The maximum bandwidth required by a VCT source on a serial connection depends on the packet transport technology. The following describes an example bandwidth calculation using Ethernet as a transport mechanism.

Assume, in the following example, there are T total destinations within a VCT system. A variable D represents a total number of time slots to be distributed by a VCT source each frame period. Using Ethernet as the packet transport method, each source could send a minimum length Ethernet packet containing one time slot to every VCT destination in the system except itself and one other. The other VCT destination receives the remaining time slots in one or more packets. This is the most inefficient distribution scenario, as this is the most inefficient use of an Ethernet frame to transfer only a single timeslot of TDM data. Each single time slot being sent to a destination must be padded with 45 additional bytes to meet the minimum packet length requirement of Ethernet. Note that there are 304 bits of header overhead required by the Ethernet protocol.
N=T−2 the number of minimum length Ethernet packets to be sent

Ethernet defines the maximum payload of a packet to be 1500 bytes. Given D time slots to be distributed, the number of maximum length Ethernet packets to be sent is determined by:
M=Integer{(D−N)/1500} number of maximum length Ethernet packets to be sent
Note: Integer{} means round down to the nearest integer i.e.: Integer{1.1}=1; Integer{0.8}=0
If (D−N)/1500 does not equal an integer, some time slots are sent in a packet that can range in size from minimum length to maximum length. The number of remaining time slot to be sent is given by:
R=D−(M×1500)−N remaining time slot to be sent
If R>46 bytes, then the size in bits of the remainder packet is given by:
RP=(R bytes×8 bits/byte+304 bits)
If R≦46 bytes, then the size in bits of the remainder packet is given by:
RP=(46 bytes×8 bits/byte+304 bits)

A minimum length Gigabit Ethernet packet and IPG (inter-packet gap) occupies 672 bit times on the Ethernet media. A minimum length packet contains 56 bits of preamble, 8 bits of start delimiter, 48 bits of source address, 48 bits of destination address, 16 bits of type/length information, 368 bits of payload, 32 bits of CRC (cyclic redundancy check), and a minimum of 96 bits of inter-packet gap (IPG).

A maximum length Gigabit Ethernet packet occupies 12,304 bit times on the media. A maximum length packet contains 56 bits of preamble, 8 bits of start delimiter, 48 bits of source address, 48 bits of destination address, 16 bits of type/length, 12,000 bits of payload, 32 bits of CRC, and a minimum of 96 bits of inter-packet gap (IPG).

Equation 1 provides an upper bound of the maximum required serial link bandwidth, in bits per second, assuming Gigabit Ethernet as the VCT packet transport technology:

$$Max Bps = \frac{\begin{matrix}\{ ( T \text{-} 2 packets ) \times 672 bits \text{/} pkt ) + \\ ( M \times 12304 bits \text{/} pkt ) + RP \}\end{matrix}}{frame period} \qquad Equation 1$$

Equation 1 calculates an upper bound on the bandwidth needed to support example VCT systems. For illustrative purposes as discussed in the examples further below, systems have been chosen with 8, 10, 12, and 14 destinations. Assuming each VCT function in a system supports D time slots, the table below shows how the scheme scales as the number of time slots increase as well as the effect of varying the number of destinations (T). From the following table, it can be seen that minimizing T assists in offsetting the inefficiency of sending only one (1) time slot in a minimum length Ethernet packet. By allowing T to grow, the problem is magnified.

TABLE 1
Required Bandwidth (bits/sec) vs. Destinations and Time Slots

| D | | | | | | |
|---|---|---|---|---|---|---|
| # time | WAN | | T = 10 | T = 12 | T = 14 | |
| slot's | Interface | T = 8 Dest. | Dest. | Dest. | Dest. | Units |
| 24 | T1 | 37,632,000 | 48,384,000 | 59,136,000 | 69,888,000 | bits/sec |
| 96 | 4 × T1 | 40,448,000 | 51,072,000 | 61,696,000 | 72,320,000 | bits/sec |
| 192 | 8 × T1 | 46,592,000 | 57,216,000 | 67,840,000 | 78,464,000 | bits/sec |
| 672 | T3 | 77,312,000 | 87,936,000 | 98,560,000 | 109,184,000 | bits/sec |
| 2016 | STS-3 | 165,760,000 | 176,384,000 | 187,008,000 | 197,632,000 | bits/sec |
| 4096 | H.110 | 301,312,000 | 311,936,000 | 322,560,000 | 333,184,000 | bits/sec |
| 8064 | STS-12 | 562,560,000 | 573,184,000 | 583,808,000 | 594,432,000 | bits/sec |

FIG. 3 shows a central switch architecture having a serial connection from a given node circuit board to a hub (e.g., centralized packet switch) that may carry both VCT and non-VCT traffic. Further, it is possible to have multiple links between a node circuit board and a hub circuit board. Some links may carry only VCT traffic and others non-VCT traffic. For example, within a circuit board, serial link(s) to the VCT processor may carrying only VCT packets. Equation 1 bounds the maximum serial link bandwidth needed for VCT traffic from a VCT processor over a single Gigabit Ethernet connection. The remaining bandwidth available on circuit board connections to the hub can be used for other traffic.

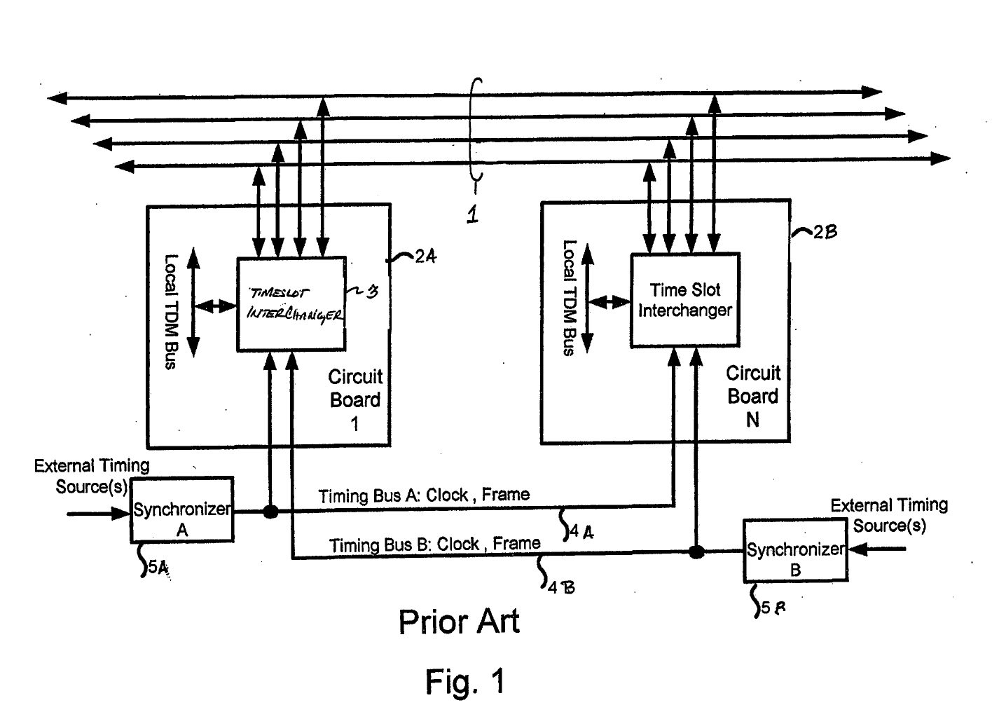

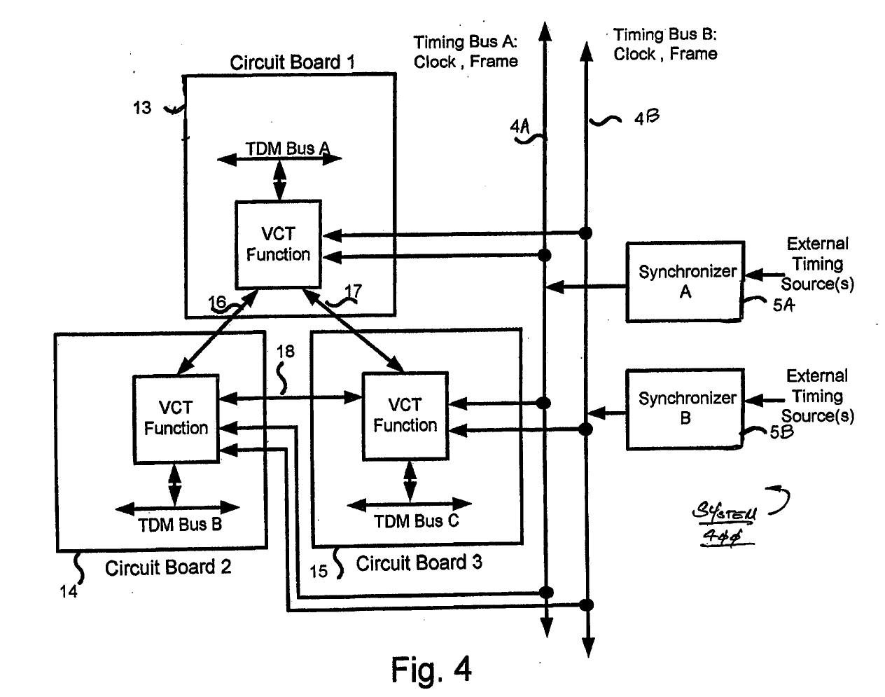

In a mesh architecture, each circuit board has a direct dedicated serial connection to other circuit boards. In this case, VCT traffic received from a source circuit board is not aggregated onto one serial link, but rather VCT traffic may be spread out over multiple connections among circuit boards. FIG. 4 shows three circuit boards 13, 14, 15 having VCT functions connected via a full mesh of direct connections (items 16, 17, 18) between the VCT functions. Synchronizers 5A-5B may perform similar function as described above with respect to FIG. 1.

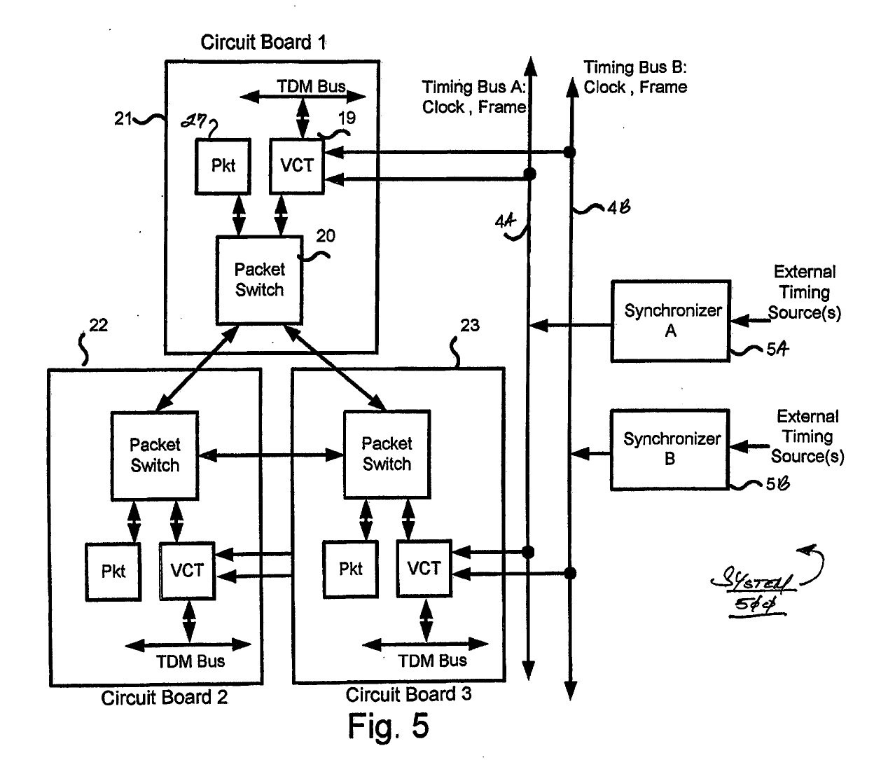

FIG. 5 shows a mesh configuration with packet switches located on each circuit board of a VCT connection system 500. As shown, a VCT processor 19 of a source circuit board 21 is coupled to one or more serial links from an on-circuit board packet switch 20. Each serial connection between circuit boards can carry a combination of VCT and regular (non VCT) packets. In one example, serial link(s) to the VCT processor may carry only VCT packets. Packet switch 20 of source circuit board 21 forwards VCT packets to the appropriate connection to reach the destination circuit board. Equation 1 is valid for the link between the VCT processor and the local switch using Ethernet as the transport.

FIG. 5 shows an example using a mesh interconnect between more than two circuit boards (e.g., boards 21, 22, 23). Each circuit board may include, for example, a full duplex point-to-point connection between itself and other circuit boards in system 500.

In system 500, each circuit board has a packet switch that connects to other circuit boards and these packet switches may also perform local packet functions. Systems having two or more circuit boards can be created using such an architecture. In FIG. 5, VCT blocks perform TDM/packet conversions as discussed above with respect to VCT function blocks. A Pkt block (e.g., block 27) represents a non-VCT packet source or sink. That is, Pkt blocks represents either non-VCT sources or destinations. Functions of synchronizers 5A-5B are similar to the synchronizers described above.

Switch Requirements

As discussed above, various embodiments of the present invention may be implemented using either direct or switched low latency connections between source and destination VCT functions. A typical distributed circuit switch TDM system exhibits an input to output delay of eight to twelve 125 μs frame times. According to one embodiment of the invention, connections are provided that exhibit similar low latency behavior using packet based technology (e.g., either direct or switched). A packet switch used to carry the VCT packets must provide latency on the order of a frame period or less, ensure no VCT packet loss due to internal queue overflow and no re-ordering of packets. If VCT traffic is mixed with non-VCT traffic on any switch port, it may be preferable that the switch support prioritized queuing on that port to ensure non-VCT packets do not delay VCT packets.

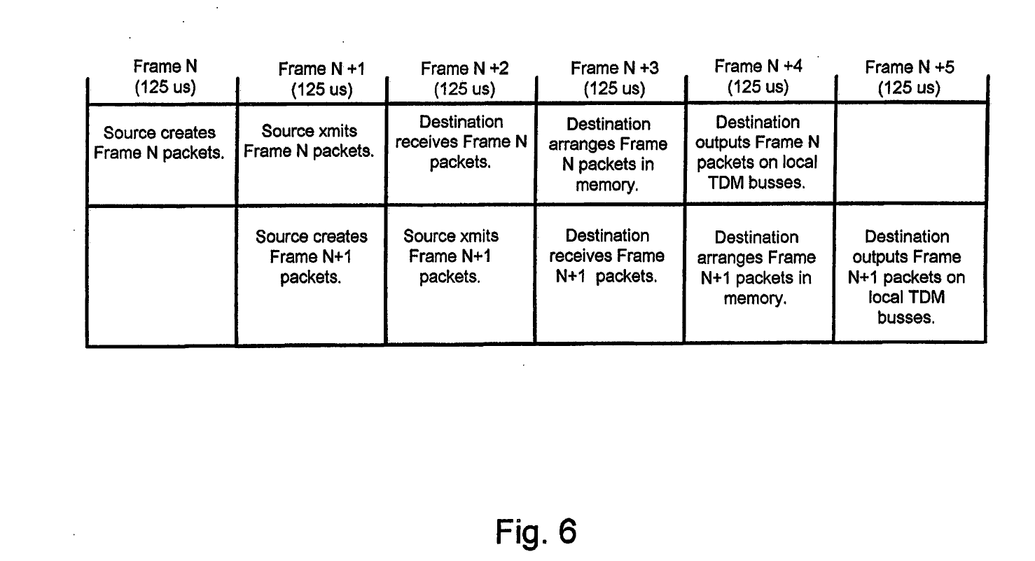

Commercially-available Ethernet switching devices enable systems having abundant switching bandwidth to be built inexpensively. Low latency is also achievable with these switching devices. Such a switching device coupled with one or more packet/TDM conversion functions that process packets in a pipelined fashion, where each pipeline stage is clocked in integer multiples of the TDM frame period, allows a system with only Ethernet connections to cheaply emulate a shared media TDM distribution system. According to one embodiment, pipeline stages may be synchronized to the TDM frame clock. Deterministic delay in transporting the packets eliminates the need for a jitter buffer at the receiver to reconstruct the TDM stream. FIG. 6 provides an example of the end-to-end (from source to receive) pipelining of frame processing in a system.

Each packet sent from a source to a destination may contain a packet header having a standard format. For example, the IEEE has standardized the contents and format of an Ethernet packet header. However, transmission of the header consumes valuable serial link bandwidth. To minimize inefficiency due to transmitting the packet header information, according to one embodiment of the invention, the minimum number of VCT packets are sent each frame period from the source to a destination. If multiple timeslots are to be transmitted from a source to a destination, these timeslots are sent in the same packet.

Timeslot data is packed into the packet payload in a manner understood by the destination. More particularly, a destination knows which time slot and TDM bus the data came from based on where the timeslot is located in the packet payload. The destination may learn this information, for example, in the section below describing connection establishment/destruction.

In one example, a receiving circuit board may determine which source circuit board the packet came from by inspecting a source address field in the packet header of the received packet. Each packet may contain from one time slot up to all the time slots on a circuit board. A circuit board having dual STS-3 framed interfaces, for example, requires a packet payload size of 4032 bytes for the timeslot (e.g., a DS0) if all the timeslots are directed to one destination circuit board. However, this payload size is much larger than a maximum size Ethernet packet payload (1500 bytes), so the VCT function might send multiple packets in this case. “Jumbo” (>1500 bytes) Ethernet packets may also be used. At the other extreme, there may be the same number of packets as there are circuit boards in the system, with 1 timeslot being located in each packet payload. The minimum Ethernet packet payload size is 46 bytes, so this transmission is very inefficient. A receiving circuit board may receive packets from all source circuit boards sending data to the receiving circuit board every frame time.

For example, consider a chassis populated with 12 octal T1 circuit boards. A circuit board having an octal T1 interface (8×24 DS0s=192 DS0s) could receive 1 packet with 192 DS0s in the packet to 11 (12 circuit boards−1) packets, each packet having one DS0 per 125 microseconds. In this example, the maximum bit rate a source or destination circuit board may have to transmit or receive is ten minimum length Ethernet packets, each containing one DS0, plus one packet containing 182 DS0s.

VCT Packet Format

Within a circuit board the TDM busses are numbered sequentially. Time slots within a given TDM bus are also numbered sequentially. In one embodiment of the invention, the VCT packet payload is packed with the lowest numbered time slot from the lowest numbered bus first and proceeds to the highest numbered time slot from the highest numbered bus last. Using Ethernet as an example, the VCT payload may be placed as shown below:

Ethernet Header
New Configuration Flag (optional)
VCT Payload

Ethernet FCS

Connection Establishment/Destruction

This section describes the steps that may be performed to establish and delete a VCT connection. The packet payload is packed in a manner understood by both source and destination circuit boards, so it may be necessary to keep the source and destination circuit boards interpretation of the packet payload format in synchronization as time slots are added or deleted to a VCT connection. Creation and destruction of connections may be performed, for example, by a separate connection entity. Such a connection entity may communicate with the source and destination circuit boards via messages.

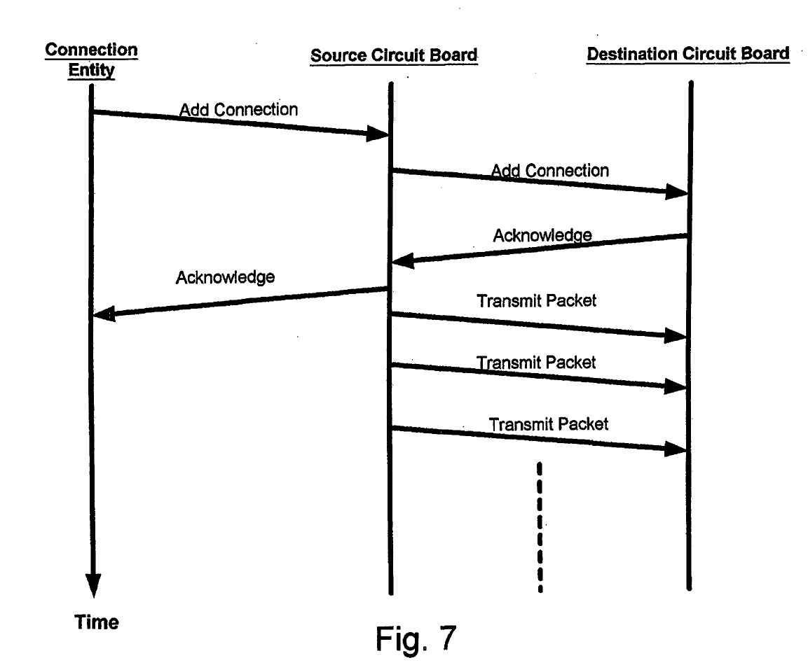

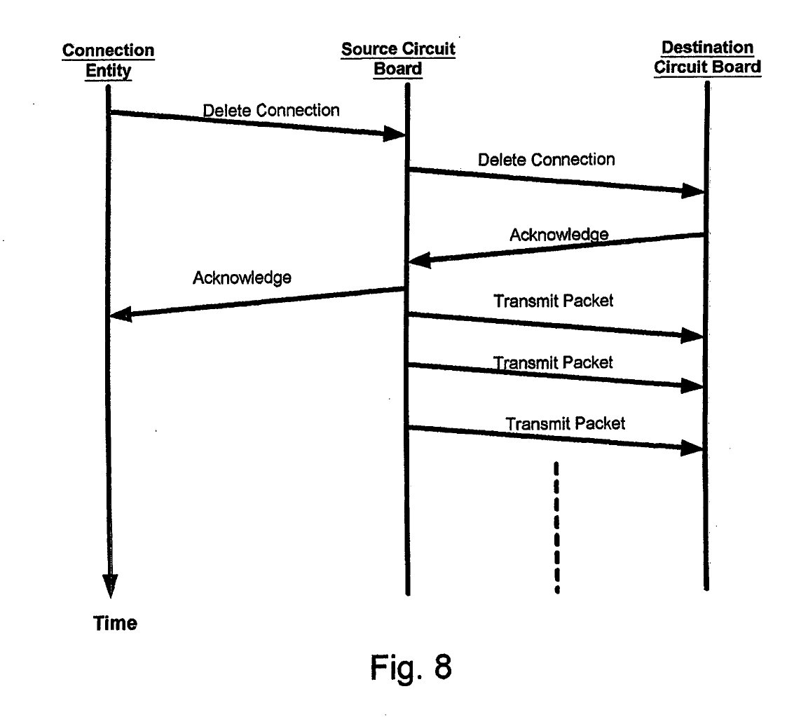

One message based protocol that may be used to establish or delete connections is shown by way of example in FIGS. 7 and 8. The connection entity passes the required connection information to the source circuit board when a connection needs to be created or destroyed. The source circuit board then passes this information to the destination circuit board (e.g., by direct connection or through a switched connection). The protocol may use messages to communicate with VCT Functions. For example, these messages may be carried in-band over the packet connection. The connection entity may be located remotely from VCT functions if connected via a packet transport mechanism. FIG. 7 illustrates one method for establishing a connection.

Steps in Establishing a Connection:

1) Connection entity sends Add Connection message to source circuit board.

2) Source circuit board sends Add Connection message to destination circuit board.

3) Destination circuit board sends Acknowledge message to the source circuit board.

4) Source circuit board sends an Acknowledge message to the Connection Entity.

5) Source circuit board starts transmitting VCT packets to destination containing new time slot(s). VCT packets sent to a destination circuit board may indicate a new payload configuration is being used by setting a new configuration flag in the VCT payload. Alternatively, the change in the VCT packet payload configuration can be signaled out of band.

Add Connection Message Contents:
Source TDM Bus
Time Slot
Destination Circuit board
Destination TDM Bus
Destination Time Slot

FIG. 8 illustrates a method for deleting a connection as discussed further below:

Steps to Delete a Connection:

1) A Connection Entity sends a Delete Connection message to a source circuit board.

2) The source circuit board sends a Delete Connection message to a destination circuit board.

3) The destination circuit board sends an Acknowledge message to the source circuit board.

4) Source circuit board sends an Acknowledge message to the Connection Entity.

5) The source circuit board removes the timeslot(s) from VCT packets to the destination circuit board. If no other timeslots are being sent to that destination circuit board no further VCT packets will be sent. If there are timeslots to send, the Source circuit board starts transmitting VCT packets to destination containing the new payload configuration. VCT packets going to a destination circuit board may indicate a new payload configuration is being used by setting a new configuration flag in the VCT payload. Alternatively, the change in the VCT packet payload configuration can be signaled out of band.

Delete Connection Message Contents:
Source TDM Bus
Source Time Slot
Destination Circuit board
Destination TDM Bus
Destination TDM Time Slot

A switch fabric, if used, may be a low latency transport mechanism. According to one embodiment, the switch fabric does not modify the packet contents or participate in any of the connect protocols described here. In this manner, the design is simplified, and latency in transmitting (and processing) packets is minimized.

Creating and Transmitting a VCT Packet:

Each frame time a source circuit board captures appropriate time slots from its local TDM busses and creates one or more packets bound for a particular destination circuit board. The payload of each packet is arranged in a fixed configuration that is understood by both the source and destination circuit boards. According to one embodiment, packets are transmitted as soon as their payloads are complete. Each VCT packet may include a control header. The control header may contain an indication of whether the current packet contains a new configuration, i.e. whether time slots were added or deleted since the last packet was transmitted.

From an overall system perspective care must be taken such that two (2) or more time slots from the same frame at a source (i.e. an N×64 Kbps connection) are always placed in the same frame at the destination circuit board in the same order they were received.

Receiving and Processing a VCT Packet:

According to one embodiment, a VCT function on a destination circuit board utilizes several sub-functions to process VCT packets. For instance, a VCT function may be implemented as a combination of a microprocessor and custom hardware (for example an FPGA) to assist the VCT function in processing TDM and packet data. This function is responsible for the protocols depicted, for example, in FIGS. 7 and 8. One possible implementation is described below.

The VCT function is also responsible for maintaining lists of pointers; one list for each VCT packet source plus a list of free pointers. Each list of pointers is organized as a linked list. Each entry in a linked list contains a bit to indicate whether the entry is active or inactive, the address in the output buffer of where to store a particular time slot, and a pointer to the next entry in the list. The end of a list is indicated by a next entry pointer value of 0. Each list may be ordered such that the first time slot received from a source is the first entry in the list; the second time slot corresponds to the second entry in the list and so on. As a packet containing time slots is unpacked the list corresponding to the source of the packet is walked to obtain the address of a location in the output buffer at which to store that time slot. When a connection is setup or destroyed, the microprocessor adds or deletes the corresponding entry in the list. To add an entry to a list, a free entry is taken from the free list. When a connection is destroyed, the entry is returned to the free list.

The output buffer may be organized as a simple ping pong (or double buffered) memory. That is, there are two identical buffers—at any given instant one buffer is outputting its data onto the local TDM highways and the other buffer is being filled with data from the next frame data. When the next frame pulse appears, the roles of the buffers swap. When outputting data onto a local TDM highway, content of the output buffer is read sequentially—i.e. timeslot 0 corresponds to byte 0, timeslot 1 corresponds to byte 1 and so forth—each byte is then serialized and placed onto the appropriate data line.

Extension to Support Redundancy

A VCT function can be configured to operate with 1+1 redundant connections and support fast switchover to a redundant link. The VCT function knows that every frame time it is supposed to receive a certain number of packets from a given source module. If the VCT function does not receive all the packets it is supposed to every frame time, or a packet is corrupted, it can autonomously select an alternate connection as the source of VCT data. To operate in a 1+1 redundant manner the VCT function provides the ability to transmit the same data out both the primary and redundant connections simultaneously. This feature allows a system of VCT functions to emulate a circuit switched digital cross connect.

As discussed above, because a jitter buffer is not used, the connections are low latency (e.g., less than a TDM frame period). Because there is low latency, a 1+1 redundant connection recovers from a failed connection in less than 50 ms, which is usually specified for circuit switch redundancy. Such a feature allows the system to emulate a circuit-switched DACS. Other conventional systems such as CES described above have packetization delays on the order of 10-20 microseconds (50-100 frame periods), and thus CES systems are not capable of functioning is such a redundant mode. According to one embodiment, one frame's worth of data is transported in a packet, and because of this, a receiver may cleanly switch over to another parallel connection if one of the connections fail.

Extension to Multiple Chassis Systems

The distribution of TDM data concept can be extended across multiple chassis using standard serial links to connect the chassis to a packet switch or network of switches. The links between a chassis and the switch may be referred to as uplinks.

A packet switch used to carry the VCT packets must provide latency on the order of a frame period or less, ensure no VCT packet loss due to internal queue overflow, and no re-ordering of packets. If VCT traffic is mixed with non-VCT traffic on any switch port then the switch may support prioritized queuing on that port to ensure non-VCT packets do not delay VCT packets. Example uplinks could consist of a Gigabit Ethernet link, multiple Gigabit Ethernet links, multiple Gigabit Ethernet links using link aggregation (802.3ad), or a 10 Gigabit Ethernet link. The size of the uplink is dependent on the amount of traffic that must be carried between the chasses.

When extending the VCT concept to multiple chassis systems, frame and bit synchronization for all the TDM busses must be maintained across all chasses connected into a system. This may be accomplished, for example, with external clock and frame signals that are supplied to all of the chasses. In one embodiment, all VCT functions within a chassis operate synchronously with respect to the system frame and bit clocks. Also, according to another embodiment, all TDM busses on cards in the system operate synchronously with respect to system frame and bit clocks.

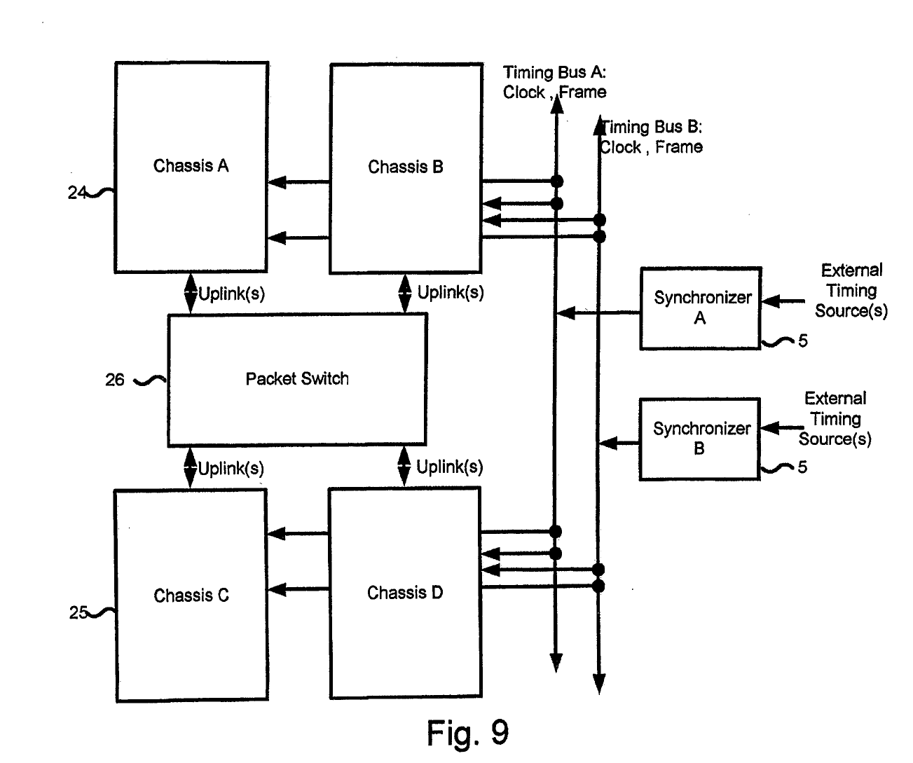

FIG. 9 shows chasses (i.e., four chasses) connected via uplinks to a packet switch 26. External synchronizers 5A-5B provide system frame and bit clocks that are distributed to all the chasses. These clocks are distributed to all the circuit boards containing a VCT function within each chassis.

As chasses are connected together, the number of circuit boards that may participate in a VCT system increases rapidly. In a VCT system the worst case serial link bandwidth to or from a circuit board is dependent on the number of VCT sources in a system. Inefficiency of packing small numbers of time slots into minimum length packets quickly eats up link bandwidth. It is important not to overload the uplink to ensure that packets are not lost or delayed excessively in transport. In addition, the VCT traffic may share an uplink with non-VCT packets so that must be factored into the desired loading.

To minimize the inefficiencies of the VCT packing algorithm in multi-chassis systems, where the number of cards can get large, an intermediate grooming function located on a chassis' uplink may be used. The grooming function receives all packets bound for the uplink from within the chassis and creates new packets that contain all the time slots bound for a destination circuit board in another chassis. For example, if two source circuit boards in chassis 24 each send one packet per frame time containing time slots to the same destination circuit board in chassis 25 the grooming function will create one packet per frame that contains all the time slots from both source circuit boards and forward that over the link to chassis 25. If the number of time slots going to a destination circuit board in a remote chassis is larger than the maximum packet size of the transport protocol the grooming function must create multiple packets.

For packets that exit a chassis the payload ordering created by a source circuit board may not be the payload ordering that a destination circuit board in another chassis ultimately sees because they may be groomed at the uplink. When setting up a multi-chassis connection new connection information received by a destination circuit board must reflect the ordering ultimately seen by that destination circuit board. The connection entity that supplies source circuit boards with connection information must have global knowledge of all TDM busses in a multi-chassis system, and controls the final payload ordering delivered to a destination circuit board.

For traffic coming into a chassis via the uplink the grooming function may receive many VCT packets from other chassis, via the uplink, each bound for the same destination circuit board. In this case, the grooming function may create a new packet containing all the time slots and deliver it to the local destination module. If the number of time slots going to a destination module in the local chassis is larger than the maximum packet size of the transport protocol the grooming function must create multiple packets. This ingress grooming is not needed if the number of chassis being connected is not large.

The grooming function needs to be able to identify VCT packets versus packets containing other types of data going to the same destination. Only VCT packets are groomed. Using Ethernet this can be achieved by marking only VCT packets with a known high priority (e.g., see IEEE standard 802.1P). The grooming function may select traffic to groom based on this field.

Ethernet Frame Format

The following table illustrates the format of an Ethernet frame as defined in the original IEEE 802.3 standard:

TABLE 2
Ethernet Frame Format

| | | | | | | | |
|---|---|---|---|---|---|---|---|
| Preamble | Start | Dest. | Source | Length/ | Payload | Pad | Frame |
| (7-bytes) | Frame | MAC | MAC | Type | Data | (0-p | Check |
| | Delimiter | Address | Address | (2- | (0-n | bytes) | Sequence |
| | (1-byte) | (6-bytes) | (6-bytes) | bytes) | bytes) | | (4-bytes) |

Preamble:

A sequence of 56 bits having alternating 1 and 0 values that are used for synchronization. They serve to give components in the network time to detect the presence of a signal, and begin reading the signal before the frame data arrives.

Start Frame Delimiter:

A sequence of 8 bits having the bit configuration 10101011 that indicates the start of the frame.

Destination & Source MAC Addresses:

The Destination MAC Address field identifies the station or stations that are to receive the frame. The Source MAC Address identifies the station that originated the frame. The 802.3 standard permits these address fields to be either 2-bytes or 6-bytes in length, but virtually all Ethernet implementations in existence today use 6-byte addresses. A Destination Address may specify either an “individual address” destined for a single station, or a “multicast address” destined for a group of stations. A Destination Address of all 1 bits refers to all stations on the LAN and is called a “broadcast address”.

Length/Type:

If the value of this field is less than or equal to 1500, then the Length/Type field indicates the number of bytes in the subsequent MAC Client Data field. If the value of this field is greater than or equal to 1536, then the Length/Type field indicates the nature of the MAC client protocol (protocol type).

Payload Data:

This field contains the data transferred from the source station to the destination station or stations. According to one embodiment of the present invention, VCT timeslots are placed in the payload section of the Ethernet packet. The maximum size of this field is 1500 bytes. If the size of this field is less than 46 bytes, then use of the subsequent “Pad” field is necessary to bring the frame size up to the minimum length.

Pad:

If necessary, extra data bytes are appended in this field to bring the frame length up to its minimum size. A minimum Ethernet frame size is 64 bytes from the Destination MAC Address field through the Frame Check Sequence.

Frame Check Sequence:

This field contains a 4-byte cyclical redundancy check (CRC) value used for error checking. When a source station assembles a MAC frame, it performs a CRC calculation on all the bits in the frame from the Destination MAC Address through the Pad fields (that is, all fields except the preamble, start frame delimiter, and frame check sequence). The source station stores the value in this field and transmits it as part of the frame. When the frame is received by the destination station, it performs an identical check. If the calculated value does not match the value in this field, the destination station assumes an error has occurred during transmission and discards the frame.

The original IEEE Ethernet standards defined the minimum frame size as 64-bytes and the maximum as 1518-bytes. These numbers include all bytes from the Destination MAC Address field through the Frame Check Sequence field. The Preamble and Start Frame Delimiter fields are not included when quoting the size of a frame. The IEEE 802.3ac standard released in 1998 extended the maximum allowable frame size to 1522-bytes to allow a “VLAN tag” to be inserted into the Ethernet frame format. In implementations that mix VCT and non-VCT packets on the same switch port, the Ethernet packet format with a VLAN tag may be used, as the VLAN tag contains a priority field (to indicate the priority of the attached frame). According to one embodiment, VCT packets may be given a higher priority than non-VCT packets to ensure timely delivery.

If present, the 4-byte VLAN tag is inserted into the Ethernet frame between the Source MAC Address field and the Length/Type field. The first 2-bytes of the VLAN tag consist of the “802.1Q Tag Type” and are always set to a value of 0x8100. The 0x8100 value is actually a reserved Length/Type field assignment that indicates the presence of the VLAN tag, and signals that the traditional Length/Type field can be found at an offset of 4-bytes further into the frame. The last 2-bytes of the VLAN tag contain the following information
The first 3-bits are a User Priority Field that may be used to assign a priority level to the Ethernet frame.
The next 1-bit is a Canonical Format Indicator (CFI) used in Ethernet frames to indicate the presence of a Routing Information Field (RIF).
The last 12-bits are the VLAN Identifier (VID) which uniquely identifies the VLAN to which the Ethernet frame belongs.

With the addition of VLAN tagging, the IEEE 802.3ac standard permitted the maximum length of an Ethernet frame to be extended from 1518-bytes to 1522-bytes. The following illustrates the format of an Ethernet frame that has been “tagged” with a VLAN identifier per the IEEE 802.3ac standard:

TABLE 3
Tagged Frame Format

| | | | | | | | | | |
|---|---|---|---|---|---|---|---|---|---|
| Preamble | Start | Dest. | Source | Length/Type = 802.1Q | Tag | Length/ | Payload | Pad | Frame |
| (7-bytes) | Frame | MAC | MAC | Tag Type | Control | Type | Data | (0-p | Check |
| | Delimiter | Address | Address | (2-byte) | Information | (2- | (0-n | bytes) | Sequence |
| | (1-byte) | (6- | (6- | | (2-bytes) | bytes) | bytes) | | (4-bytes) |
| | | bytes) | bytes) | | | | | | |

A VCT Protocol Packet for Ethernet may be formed, for example, by using the Ethernet packet format to encapsulate the VCT Packet Format within the payload field. According to one embodiment, the contents of a VCT Packet carried in the Ethernet Packet payload field are summarized in the following table:

TABLE 4
Format of Ethernet Payload

| Parameter | Octets | Definition / Dependency |
|---|---|---|
| VCT_PKT Destination Node ID(7:0) | 1 | Function of Destination ID / Set by SW |
| VCT_PKT Source Node ID(7:0) | 1 | Fixed, / Set by SW |
| VCT_PKT Miscellaneous Field(7:0) | 1 | This field contains the following: |
| Packet ID(1:0), | | Packet Fragment Identifier |
| Change Configuration Flag, | | Control RAM State Exchange |
| Spare Bits(4:0) | | Future Use |
| VCT_PKT | 1 | Packet Sequence Counter / PSC |
| Packet Sequence Number(7:0) | | Future Use |
| VCT Payload Length(15:0) | 2 | Valid VCT Data Field Length |
| VCT Payload Field | 1 to 1494 | DSO's (time slots) |
| Data Field Pad | 0 to 338 | Data Field Length |

Ethernet Payload VCT Packet Format

These parameters are multiplexed into the data stream to assemble the packet which is sent, for example, to a port of a packet switch. The need for these parameters may vary depending upon the packet switch or switch fabric (e.g., a Gigabit Ethernet MAC core) used. In one example, the Data Field Pad may be automatically added by some MAC implementations. There are some additional bits available for future use. In the future, hardware cost and utility will become better known and these can be easily implemented as needed if the VCT Packet Header already has space allocated. There are a few additional bits allocated for presently unforeseen future enhancements.

Note that the Maximum Ethernet Payload following the Ethernet Type/Length field is 1500 octets, which the VCT Packet header of 6 octets reduces to 1494 octets.

VCT Packet Source Node ID—VCT_PKT_SN_ID(7:0)—This field identifies this packet in the following ways:
1. The Switch Fabric (either A or B) which transported this packet
2. Whether this packet is a DS0 Packet, or a non DS0 bearing Packet.
3. The Source Node ID (SN_ID) of the Source Node from which this packet was sent.

The mapping is defined by the table below. All bits in this field are to be set correctly, but currently only the least significant 4 bits of the SN_ID(3:0) are used to select a VCT Node, while SN_ID(4) and DN_ID(4) are used to indicate if the packet is a DS0 packet or a non-DS0 bearing packet.

TABLE 5
VCT Packet Source and Destination Node ID Field Definition

| Bits 7, 6 | Bit 5 | Bit 4 | Bits(3:0) |
|---|---|---|---|
| Unused, | Switch Fabric Bit | DSO bearing | DSO Source or Destination |
| Set = 0 | A = 0, B = 1 | | Node ID Field |

| | | |
|---|---|---|
| Unused | Unused | SN_ID(4:0) or DN_ID(4:0) |

This field is used in the Destination Node to ‘steer’ the packet payload to the appropriate buffer. This field provides for a less expensive, higher performance hardware solution to addressing the proper Destination Node DS0 Buffer than would a CAM based look up of the 48 bit Source Address.

VCT Packet Destination Node ID—VCT_PKT_DN_ID(7:0)—This field confirms to the Destination Node that the packet has been correctly addressed. This field has no other use at present. See Source and Destination Node ID VCT Packet Field Definition and Source and Destination Node ID Field Assignments above for the use of this field.

VCT Packet Miscellaneous Field—MISC(7:0)—This field contains some spare bits and fields related to specific packets.

TABLE 6
VCT Packet Format

| Change | | | | | | | |
|---|---|---|---|---|---|---|---|
| CFG | | | | | | | |
| Flag | Unused (4:0) | | | | | PKT_ID(1:0) | |
| 0 | 4 | 3 | 2 | 1 | 0 | 1 | 0 |
| 7 | 6 | 5 | 4 | 3 | 2 | 1 | 0 |

VCT Packet Miscellaneous Field (7:0)

Miscellaneous Field VCT Packet Field Definition Packet I—PKT_ID(1:0)

This field is used to indicate which packet fragment this packet represents in the implementation of Packet Fragmentation for Switch Fabric. Packet Fragmentation is necessary if the number of DS0s to be transmitted per frame exceeds the number of DS0s which can be transported in a single Ethernet VCT Packet. Since the maximum number of DS0s per frame is 4096 in one example implementation, and an Ethernet VCT Packet can transport just under 1500 octets, the Packet ID need only take the values 0, 1 and 2. If “Jumbo Frames” are used, Packet Fragmentation is not necessary. The table below illustrates the use of the Packet ID field:

TABLE 7
Packet Identifier Format

| PKT_ID(1:0) | Packet Order |
|---|---|
| “00” | First Packet Sent |
| “01” | Second Packet Sent |
| “10” | Third Packet Sent |
| “11” | Fourth Packet Sent.* |

*DSOs only need three packet fragments.

As described above, Packet Fragmentation may be required due to a Switch Fabric payload length restriction.

The Change CFG Flag is also known as the payload configuration change indicator. This flag is used to signal from the source to the destination that the VCT packet's contents have changed. The destination must have been alerted to look for this change via a connection protocol message. Any switches involved in making the connection do not look at the change indicator. The configuration change indicator is essential to make sure the source and destination have the same interpretation of the VCT packet's content at all times.

VCT Packet Sequence Number(7:0) (VCT_PSN(7:0))—This field is not used, but is a placeholder for potential future applications.

VCT Payload Length (PL(15:0))—This 16 bit field (of which only the lower 12 bits are currently used) is followed by the VCT Payload. VCT Payload Length indicates how many of the octets which follow are valid. This parameter is used to ensure the correct number of DS0s are extracted from a VCT payload into the Destination DS0 Buffer. By checking this parameter, it may be ensured that the VCT source and destination have the same interpretation of the packet payload.

VCT Payload Field (DS0 or time slot data)—This field may be used to transport VCT Packet Payload of DS0 (also known as time slot) data. This field can contain from 1 to 1494 octets if Jumbo Frames are not supported, or from 1 to 4096 octets if Jumbo Frames are supported. TDM busses at both source and destination are numbered sequentially from 0 to N. Time slots within a TDM bus are numbered sequentially from 0 to X. Time slot 0 for all busses is marked with the Frame Sync pulse. Within the payload time slot data is packed in a pattern. One pattern that eases implementation includes packing time slots with the same number consecutively based on the number of the TDM Bus they were received from. The following is an example of how the payload field can be organized:

TABLE 8
TDM Timeslot Organization

TDM Bus 0 Time Slot 0
TDM Bus 1 Time Slot 0
TDM Bus 2 Time Slot 0
TDM Bus 3 Time Slot 0
TDM Bus 0 Time Slot 1
TDM Bus 1 Time Slot 1
TDM Bus 2 Time Slot 1
TDM Bus 3 Time Slot 1
TDM Bus 2 Time Slot 17
TDM Bus 1 Time Slot 24
TDM Bus 3 Time Slot 36
TDM Bus 0 Time Slot 100

In this example above, a total of 12 time slots are being moved from a source to a destination. The first four bytes of the payload come from time slot 0 on each of four TDM busses, and they are ordered sequentially by bus number. The next four bytes come from time slot 1 on each of four TDM Busses. The next four bytes come from various busses at various time slot numbers. Notice that the time slot number increases going from the top of the payload to the bottom of the payload. Bytes are placed into the payload in the time order that the source VCT function receives them. If the same time slot from N TDM busses needs to be placed in the payload, the bytes are ordered according to which bus they were received.

Data Field Pad—An Ethernet Frame cannot have a payload of less than 46 octets. In the event the Data Field defined above is less than 42 octets in length, this field is used to make up the difference. This field may or may not be necessary depending upon the type of MAC device, some devices add this padding automatically as needed.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Original Eighth Edition, August 2001), Section 2111.03.

1. In a data communication system, a method for distributing time division multiplexed (TDM) data, the method comprising acts of:
receiving, from at least one TDM source, at least one timeslot associated with a TDM communication;
inserting the at least one received timeslot into a packet; and
transmitting the packet to a destination capable of recovering the at least one timeslot from the transmitted packet.

2. The method according to claim 1, wherein the method further comprises an act of receiving the packet, and forwarding the timeslot to at least one TDM destination, wherein the TDM source and TDM destination are located on at least one circuit board within a communication system.

3. The method according to claim 1, wherein the at least one TDM source is a TDM bus, and wherein the act of receiving further comprises receiving the at least one timeslot from the TDM bus.

4. The method according to claim 3, wherein the act of transmitting the packet further comprises an act of transmitting the packet to the destination over a packet-based network.

5. The method according to claim 4, wherein the packet-based network includes an Ethernet network.

6. The method according to claim 4, wherein the packet-based network transmits timeslot data over a full-duplex connection.

7. The method according to claim 5, wherein the shared media network includes at least one packet switch, and wherein the act of transmitting further comprises an act of forwarding the packet by the at least one packet switch toward the destination.

8. The method according to claim 7, wherein the act of forwarding includes an act of determining where to forward the packet based on Ethernet MAC header information only.

9. The method according to claim 5, wherein the packet-based network includes a point-to-point connection between an entity associated with the TDM source and an entity associated with the TDM destination, and wherein the act of transmitting further comprises an act of transmitting the packet over the point-to-point connection.

10. The method according to claim 4, wherein the TDM bus has an associated TDM frame period, and wherein a latency associated with transmitting the packet is less than a TDM frame period.

11. The method according to claim 10, further comprising an act of receiving the packet at the destination, wherein the act of receiving does not include the use of a jitter buffer at the destination.

12. The method according to claim 1, wherein the act of inserting the at least one received timeslot into a packet, includes an act of inserting the at least one timeslot into a payload section of the packet.

13. The method according to claim 1, wherein the packet includes data link information, and wherein the act of transmitting the packet further comprises an act of transmitting the packet based only on the data link information.

14. The method according to claim 1, wherein the act of transmitting further comprises an act of transmitting, in parallel, the packet to the destination over a plurality of redundant connections.

15. The method according to claim 13, wherein the act of transmitting the packet includes transmitting the packet substantially simultaneously over the plurality of redundant connections.

16. The method according to claim 1, wherein the act of transmitting further comprises an act of transmitting the packet in order compared to one or more other packets having one or more timeslots from the at least one TDM source.

17. The method according to claim 16, wherein the act of transmitting the packet further comprises an act of transmitting the packet to the destination over a packet-based network, and wherein the act of transmitting the packet further comprises transferring the packet and the one or more other packets to the destination in order.

18. The method according to claim 1, wherein the act of transmitting the packet further comprises an act of transmitting the packet to the destination over a packet-based network to another data communication system associated with the destination.

19. The method according to claim 1, further comprising an act of indicating, to the destination when data in the at least one timeslot has changed.

20. The method according to claim 1, further comprising an act of providing a synchronization signal to the at least one TDM source and to the destination.

21. The method according to claim 20, wherein the act of providing the synchronization signal includes an act of providing the synchronization signal via a network separate from a network over which the packet is transmitted.

22. A system for communicating TDM data comprising:
a first TDM communication entity that is adapted to receive at least one timeslot, the timeslot associated with a TDM connection; and
a second TDM communication entity coupled to the first TDM communication entity through a packet-based network, wherein the first TDM communication entity is adapted to transmit a packet to the second TDM communication entity through the packet-based network, the packet including the at least one timeslot.

23. The system according to claim 22, further comprising at least one packet switch that couples the first TDM communication entity to the second TDM communication entity, and wherein the at least one packet switch is adapted to forward the packet to the second TDM communication entity.

24. The system according to claim 22, further comprising a synchronizer coupled to the first TDM communication entity and the second TDM communication entity, the synchronizer providing a synchronization signal to the first TDM communication entity and the second TDM communication entity.

25. The system according to claim 24, wherein the synchronizer is coupled to the first TDM communication entity and the second TDM communication entity separately from the packet-based network.

26. The system according to claim 25, wherein the synchronizer provides the synchronization signal to the first TDM communication entity and the second TDM communication entity over at least one connection, the at least one connection being separate from the packet-based network.

27. The system according to claim 22, wherein the latency associated with transmitting the packet to the second TDM communication entity is less than one TDM frame period, and wherein the second TDM communication entity does not implement a jitter buffer to receive one or more packets.
